(19) United States
(12) Patent Application Publication
(10) Pub. No.: US 2026/0346291 A1
(43) Pub. Date: Nov. 5, 2026

(54) CLEANING DEVICE FOR A COATING DEVICE

(71) Applicant: ABB SCHWEIZ AG, Baden (CH)

(72) Inventors: Kisumi Iida, Shinagawa-ku (JP); Kuniharu Yamauchi, Shinagawa-ku (JP)

(21) Appl. No.: 19/563,937

(22) Filed: Mar. 11, 2026

(30) Foreign Application Priority Data
Apr. 30, 2025 (JP) 2025-075526

(51) Int. Cl. B05B 15/55; B05B 13/00; B05B 15/40

(52) U.S. Cl. CPC B05B 15/55; B05B 13/002; B05B 15/40

(57) ABSTRACT

A cleaning device for performing cleaning of a coating device including an inkjet type coating head includes a coating material circulation passage having a supply passage, a return flow passage, and the coating head; first and second head switching valves connect a head section including the coating head and a non-head section not including the coating head. A first cleaning liquid supply part supplies a first cleaning liquid to the head section. Second cleaning liquid supply parts supply a second cleaning liquid to the non-head section; and a cleaning control part for controlling the first and second head switching valves, the first cleaning liquid, and the second cleaning liquid. The cleaning control part shuts off the connection between the head section and the non-head section, and supplies the first cleaning liquid to clean the head section and/or supplies the second cleaning liquid to clean the non-head section.

### TECHNICAL FIELD

The present invention relates to a cleaning device for a coating device.

### BACKGROUND

Patent Literature 1 discloses that, in a coating device comprising a coating head, the coating material circulation passage, composed of a supply passage that supplies coating material to the coating head and a return flow passage that returns coating material from the coating head to an upstream side of the supply passage, is partitioned into multiple sections, and cleaning and coating material filling are sequentially performed for each section.

### PRIOR ART LITERATURE

### Patent Literature [Patent Literature 1] Japanese Patent No. 7483116

### SUMMARY OF THE INVENTION

### Problem to be Solved by the Invention

When the above technology is applied to an inkjet type coating device, the coating material circulation passage can be partitioned into multiple sections, and cleaning can be performed independently for each section. However, in an inkjet type coating device, cleaning liquids that are usable in the coating head are limited to non-aggressive cleaning liquids. Therefore, if a cleaning liquid is selected appropriately for the section including the coating head, it may not be possible to obtain sufficient cleaning performance in other sections.

The present invention was made in view of the above circumstances, and it is an object of the present invention to provide a cleaning device for an inkjet type coating device that can ensure cleaning performance of other parts even if the coating device has a coating head for which usable cleaning liquids are limited.

### Means for Solving the Problem

A cleaning device for a coating device according to one aspect of the present invention performs cleaning of a coating device comprising an inkjet type coating head in which multiple nozzles that eject coating material toward a coating portion of a vehicle are arrayed, and comprises: a coating material circulation passage having a supply passage that supplies coating material toward the coating head, a return flow passage that is connected to a coating material evacuation side of the coating head and recovers the coating material that was not ejected from the nozzles, and the coating head; a head switching valve installed in the coating material circulation passage connecting a head section including the coating head and a non-head section adjacent to the head section; a first cleaning liquid supply part that supplies a first cleaning liquid to the head section; a second cleaning liquid supply part that supplies a second cleaning liquid different from the first cleaning liquid to the non-head section; and a cleaning control part that controls a switching state of the head switching valve and a supply state of the first cleaning liquid and the second cleaning liquid, wherein the cleaning control part, during cleaning of the coating material circulation passage, shuts off the connection between the head section and the non-head section by switching the head switching valve and supplies the first cleaning liquid to clean the head section and/or supplies the second cleaning liquid to clean the non-head section.

### Effect of the Invention

According to the present invention, it is possible to provide a cleaning device for an inkjet type coating device that can ensure cleaning performance for other parts even if the coating device has a coating head for which the usable cleaning liquids are limited.

### BRIEF DESCRIPTION OF THE DRAWINGS

FIG. 1 is a schematic diagram showing a coating robot of a cleaning device for a coating device according to a first embodiment.

FIG. 2 is a circuit diagram showing a coating material circulation passage and flow of cleaning liquid in the cleaning device for a coating device according to the first embodiment.

FIG. 3 is a circuit diagram showing a coating material circulation passage and flow of cleaning liquid in a cleaning device for a coating device according to a second embodiment.

### DETAILED DESCRIPTION

### Modes for Carrying out the Invention

### First Embodiment

Hereinafter, a cleaning device 30 for a coating device 10 according to the present embodiment will be described with reference to the drawings.

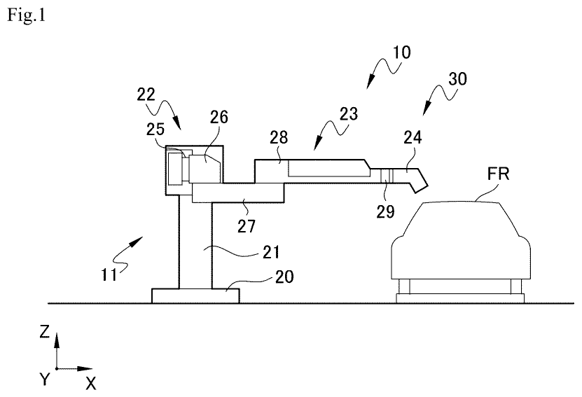

FIG. 1 is a schematic diagram showing a coating robot 11 of the cleaning device 30 for a coating device 10 according to the present embodiment. The coating robot 11 is arranged near a coating line in an automobile manufacturing plant and coats vehicle bodies FR conveyed along the coating line. In the present embodiment, the vehicle body FR of an automobile is exemplified as the object to be coated, but this object may also be something other than the vehicle body FR of an automobile.

### Coating Robot

The coating robot 11 performs coating on the vehicle body FR that is conveyed from the upstream side along the coating line. For the coating process, coating may be performed on the vehicle body FR as it flows along the coating line, or alternatively, coating may be performed after stopping the flow of the line at a predetermined position. The vehicle body FR that has been coated by the coating robot 11 is conveyed toward the downstream side of the coating line.

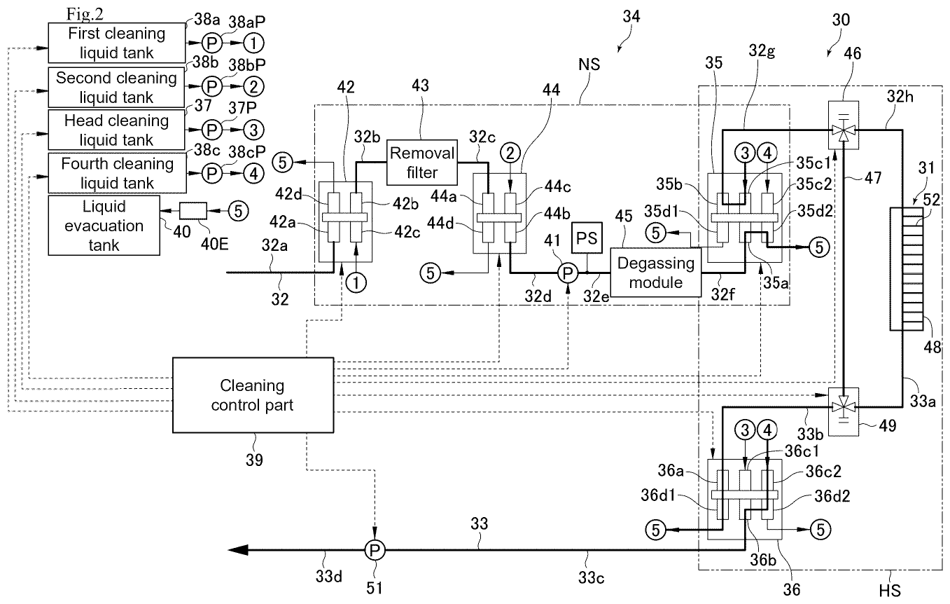

In the present embodiment, a coating robot 11 is exemplified as a device for coating the vehicle body FR, but the device need not be a coating robot 11 as long as the device has a coating material circulation passage 34 (see FIG. 2) described later. Furthermore, the coating robot 11 exemplifies a configuration in which the coating head unit 24 can turn in directions about three axes, the X axis, the Y axis, and the Z axis, but the coating head unit 24 may alternatively turn about any one axis among the X axis, the Y axis, or the Z axis, or may turn about two axes. Furthermore, the coating robot 11 may be configured to move along a guide member such as a rail.

Coating is performed for the purpose of forming a coating film on the surface of an object to be coated to provide protection and improved appearance to the surface. The coating process includes cases where coating is performed using only a coating material of a specific color or a coating material having a specific function, as well as cases where coating materials of multiple colors or coating materials having specific functions are sequentially applied in layers.

The coating robot 11 exemplifies an articulated robot, but may also be a SCARA robot so long as it is capable of coating. As shown in FIG. 1, the coating robot 11 comprises a base 20, a leg part 21, a rotary drive part 22, a robot arm 23, and a coating head unit 24.

The base 20 is a fixing member that fixes the coating robot 11 to the floor surface of the coating line and supports the coating robot 11. The base 20 may optionally be movable on the floor surface of the coating line.

The leg part 21 has a lower part fixed to the base 20 and an upper part connected to the rotary drive part 22, and extends to a vertical height suitable for performing coating with the coating robot 11.

The rotary drive part 22 is connected to the upper end of the leg part 21 and has a rotary shaft part 25 and a rotary arm 26. The rotary shaft part 25 rotates the rotary arm 26 about a direction parallel to the floor surface (the X axis direction shown in FIG. 1) by means of an unillustrated motor. The rotary arm 26 rotates the robot arm 23, connected to the rotary arm 26, about a center of rotation consisting of, for example, a straight line (the Z axis direction shown in FIG. 1) orthogonal to the center of rotation of the rotary shaft part 25.

The robot arm 23 has a first turning arm 27 and a second turning arm 28. The first turning arm 27 has one end connected to the rotary arm 26 and the other end connected to the second turning arm 28. The first turning arm 27 turns about the Z axis direction shown in FIG. 1 as the center of turning by means of an unillustrated motor installed in the rotary arm 26. The second turning arm 28 has one end connected to the first turning arm 27 and has a wrist part 29 described later at the other end. The second turning arm 28 turns about the Z axis direction shown in FIG. 1 as the center of turning by means of an unillustrated motor.

The coating head unit 24 is arranged at the most distal end side of the coating robot 11 and sprays the coating material onto the vehicle body FR of the automobile. The wrist part 29 is held between the coating head unit 24 and the second turning arm 28. The wrist part 29 turns the coating head unit 24 about at least one of the three axes (the X axis, the Y axis, and the Z axis) shown in FIG. 1.

The coating head unit 24 is supplied with the coating material by means of the supply passage 32 (see FIG. 2) of the coating material circulation passage 34 for spraying the coating material from the coating head, and sprays the coating material at an appropriate timing toward the vehicle body FR flowing on the coating line.

Next, the cleaning device 30 of the coating device 10 in the first embodiment will be described with reference to the circuit diagram of FIG. 2. When the coating device 10 operates for coating, contamination gradually adheres to the coating material flow passage and switching valves, so the cleaning device 30 periodically causes cleaning liquid to flow along the coating material flow passage to perform cleaning.

### Coating Material Circulation Passage 34

The cleaning device 30 of the coating device 10 comprises a coating material circulation passage 34 comprising a coating head 31, a supply passage 32, and a return flow passage 33; a first head switching valve 35 as a head switching valve; a second head switching valve 36 as a head switching valve; a head cleaning liquid tank 37 as a first cleaning liquid supply part; a first cleaning liquid tank 38a as a second cleaning liquid supply part and partition cleaning liquid supply part, a second cleaning liquid tank 38b as a second cleaning liquid supply part, a fourth cleaning liquid tank 38c as a second cleaning liquid supply part; a cleaning control part 39; and a liquid evacuation tank 40.

Furthermore, a head cleaning liquid pump 37P as a pressurization part, a first cleaning liquid pump 38aP as a pressurization part, a second cleaning liquid pump 38bP as a pressurization part, and a fourth cleaning liquid pump 38cP as a pressurization part, for respectively pumping the cleaning liquid in each tank toward the coating material circulation passage 34, are arranged in proximity to the head cleaning liquid tank 37, the first cleaning liquid tank 38a, the second cleaning liquid tank 38b, and the fourth cleaning liquid tank 38c.

In the following description, in the supply passage 32, with regard to the supply direction of coating material, the unillustrated coating material tank side will be referred to as the upstream side, and the coating head 31 side will be referred to as the downstream side. Furthermore, in the return flow passage 33, the coating head 31 side will be referred to as the upstream side and the coating material tank side will be referred to as the downstream side.

The coating head 31 is an inkjet type coating head in which multiple nozzles 52 that eject coating material toward the coating portion of the vehicle are arrayed. The coating head 31 has a nozzle forming surface 48 on which multiple nozzles 52 are arrayed, and the coating material supplied via the supply passage 32 is ejected from each of the multiple nozzles 52 to form a coating film on the surface of the vehicle body FR. A nozzle row, not illustrated, is composed of a predetermined number of nozzles 52.

The supply passage 32 is a flow passage that supplies the coating material stored in an unillustrated coating material tank toward the coating head 31. The supply passage 32 is sectionalized into flow passages 32a to 32h by multiple component parts installed in the supply passage 32. The coating material in the supply passage 32 is pumped by a first gear pump 41 installed in the middle of the supply passage 32.

In the supply passage 32, a first partition switching valve 42 as a partition switching valve, a removal filter 43, a second partition switching valve 44 as a partition switching valve, a first gear pump 41, a pressure gauge PS, a degassing module 45, a first head switching valve 35, and a first three-way valve 46 are arranged sequentially from the upstream side.

The return flow passage 33 is a flow passage that returns the coating material that was not used in the coating head 31 to the unillustrated coating material tank. Details of the return flow passage 33 will be described later.

The coating material circulation passage 34 is a circulation circuit that, when performing coating on the vehicle body FR, supplies the coating material stored in the coating material tank to the coating head 31 via the supply passage 32 and returns the coating material that was not used in the coating head 31 to the coating material tank via the return flow passage 33. Furthermore, the coating material circulation passage 34 also functions as a circulation circuit that returns the coating material stored in the coating material tank from the supply passage 32 via a bypass flow passage 47, described later, and through the return flow passage 33 to the coating material tank when coating is not being performed on the vehicle body FR.

The first head switching valve 35 is installed in the coating material circulation passage 34 (between the flow passage 32f and the flow passage 32g) that connects the head section HS, which contains the coating head 31, with the supply passage 32 adjacent to the head section HS. The second head switching valve 36 is installed in the coating material circulation passage 34 (between the return flow passage 33b and the return flow passage 33c) that connects the head section HS, which includes the coating head 31, with the return flow passage 33 adjacent to the head section HS.

The head cleaning liquid tank 37 supplies head cleaning liquid to the head section HS during cleaning of the head section HS, which includes the coating head 31. In the inkjet type coating device 10, since the coating head 31 is relatively susceptible to aggression of cleaning liquid, the head cleaning liquid is stored in advance in the head cleaning liquid tank 37 appropriately for the aggression resistance of the coating head 31. It should be noted that the expression that the coating head 31 is relatively susceptible to aggression of cleaning liquid indicates the following. Namely, the coating head 31 is made by laminating thin substrates, and the substrates are bonded to each other with adhesive. Therefore, the coating head 31 being relatively susceptible to aggression of cleaning liquid indicates that the aforementioned adhesive is susceptible to damage during cleaning with cleaning liquid containing, for example, organic solvents, etc. as a component.

The first cleaning liquid tank 38a, the second cleaning liquid tank 38b, and the fourth cleaning liquid tank 38c pump the first cleaning liquid, the second cleaning liquid, and the fourth cleaning liquid, respectively, by means of the first cleaning liquid pump 38aP, the second cleaning liquid pump 38bP, and the fourth cleaning liquid pump 38cP, to the non-head section NS during cleaning of the non-head section NS adjacent to the head section HS, according to the number of the flow passage leading to the valve. Since the non-head section NS does not include the coating head 31, which is susceptible to aggression of cleaning liquid, to improve cleaning performance, cleaning liquid having higher cleaning performance than the head cleaning liquid is stored in advance in the first cleaning liquid tank 38a, the second cleaning liquid tank 38b, and the fourth cleaning liquid tank 38c. The first cleaning liquid, the second cleaning liquid, and the fourth cleaning liquid may be the same, or may be different types of cleaning liquid according to the section in which the cleaning liquid is used.

The liquid evacuation tank 40 discharges, into a storage container, the cleaning liquid that was discharged from the coating material circulation passage 34 via each switching valve. The liquid evacuation tank 40 has a vacuum ejector 40E as a suction part that sucks the discharged cleaning liquid from the coating material circulation passage 34.

The cleaning control part 39 performs cleaning of the coating material circulation passage 34 by operating the component parts installed in the coating material circulation passage 34 extending from the supply passage 32 through the coating head 31 to the return flow passage 33 in synchronization. The cleaning control part 39 will be described later.

It should be noted that FIG. 2 shows the circuit of the coating material circulation passage 34 when performing coating, but since the present embodiment is for the cleaning device 30 of the coating device 10, the flow of cleaning liquid when cleaning is performed by causing cleaning liquid to flow through that circuit will be described hereinafter. In particular, in the present embodiment, a detailed description will be provided regarding the point that when cleaning the coating device 10 having an inkjet type coating head 31 which does not have high aggression resistance to cleaning liquid, the section including the coating head 31 is separated from other sections, and cleaning is performed using respectively different cleaning liquids.

### Supply Passage 32

Multiple component parts installed in the coating material circulation passage 34 will be described. It should be noted that in the following description, arrows connecting to each switching valve from the head cleaning liquid tank 37 and the first, second, and fourth cleaning liquid tanks 38a, 38b, and 38c via numbers 1 to 4 indicate flow passages through which cleaning liquid is supplied to each switching valve from the head cleaning liquid tank 37 and the first, second, and fourth cleaning liquid tanks 38a, 38b, and 38c corresponding to the respective number. Furthermore, arrows connected from each switching valve to the liquid evacuation tank 40 via number “5” indicate flow passages through which cleaning liquid flows from each switching valve to the liquid evacuation tank 40. It should be noted that the head cleaning liquid tank 37 and the first, second, and fourth cleaning liquid tanks 38a, 38b, and 38c may contain different types of cleaning liquid for each number.

The first partition switching valve 42 installed on the upstream-most side of the coating material circulation passage 34 has four valve parts 42a, 42b, 42c, and 42d.

The valve part 42a is connected to the flow passage 32a, and the valve part 42b is connected to the flow passage 32b. Therefore, during cleaning of the coating material circulation passage 34, the cleaning control part 39 places the valve part 42a and the valve part 42b into an open state, and cleaning liquid from the flow passage 32a flows toward the flow passage 32c.

The removal filter 43 is connected to a downstream side end part of the flow passage 32b connected to the valve part 42b of the first partition switching valve 42. The removal filter 43 is installed at a location where the operation of the coating robot 11 does not affect the removal performance of the removal filter 43, such as on the leg part 21 of the coating robot 11 or on the floor surface of the coating line.

The removal filter 43 removes foreign matter such as coarse foreign matter and pigment aggregates contained in the coating material flowing through the supply passage 32, as well as bubbles contained in the coating material that exceed a predetermined bubble size. The removal filter 43 is a mesh-like body such as a wire mesh or resin mesh, a porous body, or a metal plate with fine through-holes formed therein. As the mesh-like body, for example, metal mesh filters, metal fibers, fine strands of metal known as SUS (Steel Use Stainless) made into the form of felt, compression-sintered metal sintered filters, electroformed metal filters, electron beam processed metal filters, laser beam processed metal filters, and the like can be used.

The second partition switching valve 44 is connected to the downstream side end part of the flow passage 32c connected to the downstream side of the removal filter 43. The second partition switching valve 44, similarly to the first partition switching valve 42, has four valve parts 44a, 44b, 44c, and 44d.

The valve part 44a is connected to the flow passage 32c, and the valve part 44b is connected to the flow passage 32d. Therefore, during cleaning of the coating material circulation passage 34, the cleaning control part 39 places the valve part 44a and the valve part 44b into an open state, and cleaning liquid from the flow passage 32c flows toward the flow passage 32d.

The first gear pump 41, based on a command from the cleaning control part 39, draws in cleaning liquid from the flow passage 32d and pumps the drawn-in cleaning liquid toward the coating head 31. Therefore, the pressure inside the flow passage 32d on the upstream side of the first gear pump 41 becomes negative pressure, and after the cleaning liquid is drawn into the flow passage, the cleaning liquid is pumped from the flow passage 32d connected to the upstream side of the first gear pump 41 to the flow passage 32e connected to the downstream side of the first gear pump 41.

The pressure gauge PS is connected to the flow passage 32e on the downstream side of the first gear pump 41. The pressure gauge PS measures the pressure of the cleaning liquid in the flow passage 32e pumped by the first gear pump 41. The first gear pump 41 is driven and controlled so that the pressure detected by the pressure gauge PS remains constant. It should be noted that the aforementioned pressure gauge PS is arranged in the flow passage 32e on the upstream side of the degassing module 45, but instead of arranging a pressure gauge PS in the flow passage 32e, the pressure gauge PS may also be arranged in the flow passage 32f on the downstream side of the degassing module 45, or may be arranged in both the flow passage 32e and the flow passage 32f. Furthermore, the pressure gauge PS may be arranged in at least one of the flow passage 32b on the upstream side of the removal filter 43 and the flow passage 32c on the downstream side thereof.

The degassing module 45 is connected to the downstream side end part of the flow passage 32e connected to the downstream side of the first gear pump 41. The degassing module 45 is provided to remove (degas) dissolved gas and bubbles present in the coating material. For the degassing module 45, for example, a hollow fiber membrane bundle made by bundling multiple hollow fiber membranes can be used.

The first head switching valve 35 is connected to the downstream side end part of the flow passage 32f connected to the downstream side of the degassing module 45. The first head switching valve 35 has six valve parts 35a, 35b, 35c1, 35c2, 35d1, and 35d2.

The valve part 35a is connected to the flow passage 32f, and the valve part 35b is connected to the flow passage 32g. Furthermore, the valve part 35d2 is connected to the valve parts 35a, 35c2, and the liquid evacuation tank 40. The flow passage of the valve part 35d2 is not connected to the valve parts 35b, 35c1, and 35d1, but is connected to the valve part 35a and the valve part 35c2. Therefore, during cleaning, the cleaning control part 39 opens the valve part 35a and the valve part 35d2, and the coating material drainage liquid in the flow passage 32f flows to the liquid evacuation tank 40 via the valve part 35a and the valve part 35d2.

Furthermore, the valve part 35c1 is connected to the head cleaning liquid tank 37. Therefore, during cleaning, the cleaning control part 39 opens the valve part 35c1 and the valve part 35b, and the head cleaning liquid from the head cleaning liquid tank 37 flows from the valve part 35c1 via the valve part 35b to the flow passage 32g.

Furthermore, the valve part 35c2 is connected to the fourth cleaning liquid tank 38c. Therefore, when the cleaning control part 39 opens the valve part 35c2 and the valve part 35d2, the fourth cleaning liquid flows from the fourth cleaning liquid tank 38c to the liquid evacuation tank 40 via the valve part 35c2 and the valve part 35d2, whereby the internal flow passage of the first head switching valve 35 can be cleaned.

The first three-way valve 46 is connected to the downstream side end part of the flow passage 32g connected to the valve part 35b of the first head switching valve 35. The first three-way valve 46 maintains a state in which the flow passage 32g and the flow passage 32h connected to the coating head 31 on the downstream side are in communication during cleaning of the coating head 31. The first three-way valve 46 can switch to a state in which the flow passage 32g and a first bypass flow passage 47 described later are in communication when cleaning of the coating head 31 is not being performed.

The coating head 31 is at the downstream side end part of the flow passage 32h and is connected to the upstream side end part of the flow passage 33a of the return flow passage 33. That is, the coating head 31 is arranged between the downstream side end part of the supply passage 32 and the upstream side end part of the return flow passage 33. The cleaning liquid used for cleaning in the coating head 31 flows back to the coating material tank via the return flow passage 33.

The first bypass flow passage 47 connects the first three-way valve 46 and a second three-way valve 49 described later, and when the cleaning liquid is not circulated to the coating head 31, causes the cleaning liquid supplied from the supply passage 32 to bypass the coating head 31 and flow back to the return flow passage 33.

### Return Flow Passage 33

The return flow passage 33 is a flow passage that causes the coating material not used by the coating head 31, or the coating material circulating through the coating material circulation passage 34, to flow toward the downstream side of the return flow passage 33, which is the upstream side of the supply passage 32, and returns the coating material to the coating material tank. The return flow passage 33 is sectionalized into flow passages 33a to 33d by multiple component parts installed in the return flow passage 33. The cleaning liquid in the return flow passage 33 is pumped by a second gear pump 51, described later, installed in the middle of the return flow passage 33.

In the return flow passage 33, a second three-way valve 49, a second head switching valve 36, and a second gear pump 51 are arranged sequentially from the upstream side.

The second three-way valve 49 is connected to the downstream side end part of the flow passage 33a. The second three-way valve 49 maintains a state in which the flow passage 33a and the flow passage 33b connected on the downstream side to the valve part 36a of the second head switching valve 36, described later, are in communication during cleaning of the coating head 31. Furthermore, the second three-way valve 49 switches to a state in which the first bypass flow passage 47 and the flow passage 33b are in communication when cleaning of the coating head 31 is not being performed.

The second head switching valve 36 is connected to the downstream side end part of the flow passage 33b connected to the downstream side of the second three-way valve 49. The second head switching valve 36 has six valve parts 36a, 36b, 36c1, 36c2, 36d1, and 36d2.

The valve part 36a is connected to the flow passage 33b, and the valve part 36b is connected to the flow passage 33c. Furthermore, the valve part 36d1 is connected to the liquid evacuation tank 40. Therefore, during cleaning, the cleaning control part 39 opens the valve part 36a and the valve part 36d1, and the cleaning liquid in the flow passage 33b flows to the liquid evacuation tank 40 via the valve part 36a and the valve part 36d1.

Furthermore, the valve part 36c2 is connected to the fourth cleaning liquid tank 38c. The flow passage of the valve part 36c2 is not connected to the valve parts 36a, 36c1, and 36d1, and is connected only to the valve parts 36b and 36d2. Therefore, the cleaning control part 39 opens the valve part 36c2 and the valve part 36b, and the fourth cleaning liquid supplied from the fourth cleaning liquid tank 38c flows to the flow passage 33c via the opened valve part 36b.

It should be noted that when the cleaning control part 39 opens the valve part 36c2 and the valve part 36d2, the fourth cleaning liquid flows from the fourth cleaning liquid tank 38c to the liquid evacuation tank 40 via the valve part 36c2 and the valve part 36d2, whereby the internal flow passage of the second head switching valve 36 can be cleaned.

The second gear pump 51 is connected to the downstream side end part of the flow passage 33c. The second gear pump 51 draws in the cleaning liquid flowing through the flow passage 33c and pumps the cleaning liquid to the flow passage 33d connected to the downstream side of the second gear pump 51.

### Control Part

During cleaning of the coating material circulation passage 34, the cleaning control part 39 performs switching control of the first partition switching valve 42, the second partition switching valve 44, the first head switching valve 35, and the second head switching valve 36 to control the supply of cleaning liquid from the head cleaning liquid tank 37 and the first, second, and fourth cleaning liquid tanks 38a, 38b, and 38c, and the discharge of cleaning liquid to the liquid evacuation tank 40. Here, the cleaning control part 39 controls the pumps 37P, 38aP, 38bP, and 38cP provided for each cleaning liquid to pump the cleaning liquid to the respective flow passage. Furthermore, the cleaning control part 39 controls the vacuum ejector 40E to suck the cleaning liquid and discharge the cleaning liquid to the liquid evacuation tank 40.

Furthermore, the cleaning control part 39 performs switching control of the first three-way valve 46 and the second three-way valve 49 to perform switching control so that the cleaning liquid in the head section HS flows toward the coating head 31 side or toward the side that bypasses the coating head 31. Furthermore, the cleaning control part 39 controls the rotational speed of the first gear pump 41 and the second gear pump 51 to pump the cleaning liquid in the supply passage 32 or the return flow passage 33.

As described above, when the cleaning liquid flows from the upstream side of the supply passage 32 through the coating head 31 to the downstream side of the return flow passage 33 during cleaning of the coating material circulation passage 34, the coating material circulation passage 34 is separated into the head section HS and the non-head section NS by the first head switching valve 35 and the second head switching valve 36. That is, the cleaning control part 39 performs switching control of the first head switching valve 35 and the second head switching valve 36 to perform partitioning into a state where the cleaning liquid can flow to one of the head section HS including the coating head 31 and the non-head section NS not including the coating head 31, pumps the cleaning liquid in the supply passage 32 from the upstream side to the first head switching valve 35 by means of the first gear pump 41, and pumps the cleaning liquid in the return flow passage from the second head switching valve 36 to the downstream side by means of the second gear pump 51.

### Second Embodiment

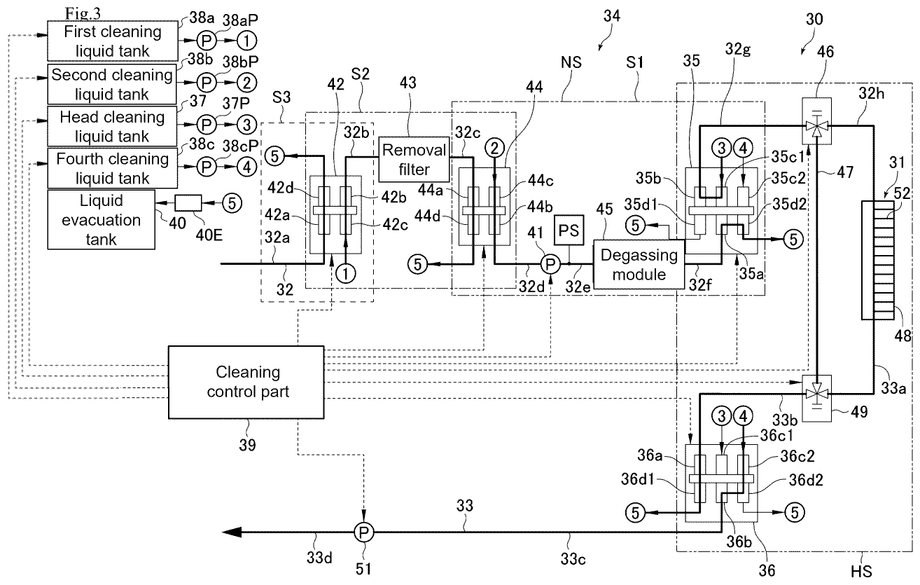

Next, the cleaning device 30 of the coating device 10 in the second embodiment will be described with reference to the circuit diagram of FIG. 3. It should be noted that the same components as in the first and second embodiments will be assigned the same reference numerals and description thereof will be omitted.

### Coating Material Circulation Passage 34

The present embodiment differs from the first embodiment in the aspect that when cleaning the non-head section NS that does not include the coating head 31, the non-head section NS is divided into multiple sections and cleaned with different cleaning liquids. FIG. 3 is a circuit diagram showing the flow of cleaning liquid that cleans the coating material circulation passage 34 of the cleaning device 30 of the coating device 10 according to the present embodiment.

### Supply Passage 32-S1

In the second partition switching valve 44, the valve part 44c is connected to the second cleaning liquid tank 38b. Therefore, during cleaning, the cleaning control part 39 opens the valve part 44b and the valve part 44c, and the cleaning liquid supplied from the second cleaning liquid tank 38b flows through the opened valve part 44c to the flow passage 32d connected to the valve part 44b. The cleaning liquid that has flowed in this manner flows to the downstream side along the supply passage 32, and as shown in the first embodiment, the cleaning liquid is discharged from the valve part 35d2 to the liquid evacuation tank 40 via the valve part 35a connected to the flow passage 32f of the supply passage 32.

As a result, the portion between the second partition switching valve 44 and the first head switching valve 35 is partitioned into the first section S1, and the flow passage in the first section S1, the first gear pump 41, the degassing module 45, and the like can be intensively cleaned.

### Supply Passage 32-S2

In the first partition switching valve 42, the valve part 42c is connected to the first cleaning liquid tank 38a. Therefore, the cleaning control part 39 opens the valve part 42b and the valve part 42c, and the cleaning liquid supplied from the first cleaning liquid tank 38a flows through the opened valve part 42c to the flow passage 32b connected to the valve part 42b. The cleaning liquid that has flowed in this manner flows through the removal filter 43 to the flow passage 32c.

In the second partition switching valve 44, the valve part 44d is connected to the liquid evacuation tank 40. Therefore, the cleaning control part 39 opens the valve part 44a and the valve part 44d, and the cleaning liquid that has flowed through the flow passage 32c connected to the opened valve part 44a is discharged to the liquid evacuation tank 40 via the valve part 44d.

As a result, the portion between the first partition switching valve 42 and the second partition switching valve 44 is partitioned into the second section S2, and the flow passages 32b, 32c between the first partition switching valve 42 and the second partition switching valve 44, the removal filter 43, and the like can be intensively cleaned.

### Supply Passage 32-S3

In the first partition switching valve 42, the valve part 42d is connected to the liquid evacuation tank 40. Therefore, when the cleaning control part 39 opens the valve part 42a and the valve part 42d, the cleaning liquid that has flowed through the flow passage 32a connected to the opened valve part 42a is discharged to the liquid evacuation tank 40 via the valve part 42d.

As a result, the section on the upstream side of the first partition switching valve 42 is partitioned into the third section S3, and the section up to the coating material tank can be intensively cleaned.

### Modified Examples

In the above embodiment, when cleaning the head section HS, the cleaning liquid is made to flow to the coating head 31, but the cleaning liquid may also be made to flow, at one's discretion, to the bypass passage 47 that bypasses the coating head 31. As a result, the bypass passage 47 can be cleaned.

Furthermore, in the second embodiment described above, the non-head section NS is further partitioned into three sections, and cleaning is performed independently in each section, but it is not necessary to switch all the switching valves to partition the sections, and adjacent sections across a switching valve may be combined into one section. As a result, by making sections where the type of cleaning liquid used is the same into one section, the cleaning liquid can be made to flow to locations that pass through the interior of the switching valves when the coating material circulates, and the cleaning performance can be improved.

Furthermore, in the above embodiment, in the coating material circulation passage 34, forward direction cleaning is performed in which the supply passage 32 is cleaned from the upstream side, the coating head 31 is cleaned from the supply passage 32 side toward the return flow passage 33 side, and the return flow passage 33 is cleaned toward the downstream side; however, reverse direction cleaning may also be performed, in which the direction of flow of the cleaning liquid is reversed in all cases. In this case, the cleaning control part 39 changes the combination of valve parts of each switching valve to be opened.

Furthermore, in the above embodiment, when cleaning the head section HS, the coating head 31 remained open, but a cap may be installed over the nozzle forming surface 48 (nozzle 52) to seal the surface. As a result, when cleaning the head section HS, dripping of cleaning liquid from the nozzle 52 can be reduced. Furthermore, because the nozzle forming surface 48 is sealed by the cap, the internal flow passage of the coating head 31 can be placed into a pressurized state, and cleaning performance can be improved.

### Supplementary Description of Embodiments

The embodiments described above all show a preferred specific example of the present invention. The numerical values, components, arrangement positions of components, order of connections, etc. shown in the above embodiments are examples and are not intended to limit the present invention. Furthermore, the drawings are not necessarily illustrated strictly.

Although embodiments of the present invention have been described above, the above embodiments merely show some application examples of the present invention, and do not have the purport of limiting the technical scope of the present invention to the specific configurations of the above-described embodiments.

The series of processes described above can be executed by hardware or can be executed by software. When the series of processes are executed by software, the programs constituting the software are installed from a program recording medium into, for example, a general-purpose computer or the like that allows execution of various functions by installing various programs, or a computer in which dedicated hardware is incorporated.

It should be noted that the programs executed by the computer may be programs in which processing is performed in a time series following the order described in the present specification, or may be programs in which processing is performed in parallel or with the necessary timing, such as when a call is made.

Furthermore, in each of the embodiments described above, it was assumed that what is used for cleaning is cleaning liquid, but besides cleaning liquid, cleaning air may also be used. It should be noted that the cleaning liquid and the cleaning air may also be interpreted together as “cleaning liquid”.

### Supplementary Notes

The content set forth in the several embodiments described above may be understood, for example, as follows.

### (1) Different Cleaning Liquids

A cleaning device 30 for a coating device 10 that performs cleaning of a coating device 10 comprising an inkjet type coating head 31 in which multiple nozzles 52 that eject coating material toward a coating portion of a vehicle are arrayed, comprising:
a coating material circulation passage 34 having a supply passage 32 that supplies coating material toward the coating head 31, a return flow passage 33 that is connected to the coating material evacuation side of the coating head 31 and recovers coating material that was not ejected from the nozzles 52, and the coating head 31;
first and second head switching valves 35, 36 installed in the coating material circulation passage 34 that connects a head section HS including the coating head 31 and a non-head section NS adjacent to the head section HS;
a head cleaning liquid tank 37 that supplies a first cleaning liquid to the head section HS;
first, second, and fourth cleaning liquid tanks 38a, 38b, 38c that supply a second cleaning liquid different from the first cleaning liquid to the non-head section NS; and
a cleaning control part 39 that controls the switching state of the first and second head switching valves 35, 36 and the supply state of the first cleaning liquid and the second cleaning liquid;
wherein:
the cleaning control part 39, during cleaning of the coating material circulation passage 34, switches the first and second head switching valves 35, 36 to shut off the connection between the head section HS and the non-head section NS, and supplies the first cleaning liquid to clean the head section HS and/or supplies the second cleaning liquid to clean the non-head section NS.

As a result, when cleaning the inkjet type coating device 10, the head section HS including the coating head 31, which has low aggression resistance, can be partitioned from the non-head section NS including other flow passages and cleaned, so that while using relatively low aggressive cleaning liquid in the head section HS including the coating head 31, more aggressive cleaning liquid can be used in the other non-head section NS. Therefore, insufficient cleaning power due to the fact that all sections are cleaned with low aggressive cleaning liquid appropriate for the coating head 31 can be avoided, the cleaning performance for the coating device 10 as a whole can be improved, and the cleaning time can be shortened.

### (2) Non-Head Section Zoning

Furthermore, the cleaning device may comprise one or more first and second partition switching valves 42, 44 that are installed in the coating material circulation passage 34 in the non-head section NS and partition the coating material circulation passage 34 into a plurality of predetermined areas, and first, second, and fourth cleaning liquid tanks 38a, 38b, 38c that supply, as the second cleaning liquid, different partition cleaning liquid for each predetermined area to the plurality of predetermined areas, wherein the cleaning control part 39 may partition a portion of the coating material circulation passage 34 into predetermined areas by switching the first and second partition switching valves 42, 44 during cleaning of the coating material circulation passage 34, and supply partition cleaning liquid to the predetermined areas partitioned by means of the first, second, and fourth cleaning liquid tanks 38a, 38b, 38c to perform cleaning.

As a result, the section other than the section including the coating head 31 can be further partitioned into multiple sections, so cleaning can be performed using cleaning liquid having different aggressiveness for each of the multiple sections. Therefore, cleaning can be performed using cleaning liquid having optimal aggressiveness based on different aggression resistance for each section, so improvement of cleaning performance and shortening of cleaning time can be achieved for each section, and as a result, improvement of cleaning performance and shortening of cleaning time for the coating device 10 as a whole can also be achieved.

### (3) Vacuum Ejector

Furthermore, the cleaning device may comprise a head cleaning liquid pump 37P, a first cleaning liquid pump 38aP, a second cleaning liquid pump 38bP, and a fourth cleaning liquid pump 38cP that pressurize the cleaning liquid supplied to the coating material circulation passage 34, and a vacuum ejector 40E that sucks and discharges the cleaning liquid supplied by the head cleaning liquid pump 37P, the first cleaning liquid pump 38aP, the second cleaning liquid pump 38bP, and the fourth cleaning liquid pump 38cP from the coating material circulation passage 34.

As a result, the cleaning liquid pumped from each cleaning liquid tank to the coating material circulation passage 34 by the pumps 37P, 38aP, 38bP, 38cP returns to the liquid evacuation tank 40 due to the pressure at the time of supply after cleaning of the flow passage, and in addition to this, by operating the vacuum ejector 40E to suck the cleaning liquid, the discharge performance of the cleaning liquid can be improved. Therefore, even with specifications where the return flow passage 33 or the supply passage 32 is long, deterioration of cleaning performance and increase in cleaning time of the coating material circulation passage 34 can be suppressed.

### (4) Alternate Cleaning

Furthermore, forward direction cleaning, in which at least one of the first cleaning liquid and the second cleaning liquid flows from the supply passage 32 to the return flow passage 33 in the coating material circulation passage 34, and reverse direction cleaning, in which at least one of the first cleaning liquid and the second cleaning liquid flows from the return flow passage 33 to the supply passage 32 in the coating material circulation passage 34, can be alternately performed.

As a result, even if contamination that cannot be removed only by the flow of cleaning liquid from one direction adheres to the coating material circulation passage 34, it may be possible to remove the contamination by the flow of cleaning liquid from the reverse direction. Therefore, by alternately performing forward direction cleaning and reverse direction cleaning, the cleaning performance for the coating material circulation passage 34 can be improved.

### Explanation of References

10 Coating device
30 Cleaning device
31 Coating head
32 Supply passage
33 Return flow passage
34 Coating material circulation passage
35 First head switching valve (head switching valve)
36 Second head switching valve (head switching valve)
37 Head cleaning liquid tank (first cleaning liquid supply part)
37P Head cleaning liquid pump (pressurization part)
38a First cleaning liquid tank (second cleaning liquid supply part, partition cleaning liquid supply part)
38aP First cleaning liquid pump (pressurization part)
38b Second cleaning liquid tank (second cleaning liquid supply part, partition cleaning liquid supply part)
38bP Second cleaning liquid pump (pressurization part)
38c Fourth cleaning liquid tank (second cleaning liquid supply part, partition cleaning liquid supply part)
38cP Fourth cleaning liquid pump (pressurization part)
39 Cleaning control part
40E Vacuum ejector (suction part)
42 First partition switching valve (partition switching valve)
44 Second partition switching valve (partition switching valve)
52 Nozzle
HS Head section
NS Non-head section

1. A cleaning device for a coating device, which performs cleaning of a coating device comprising an inkjet type coating head in which multiple nozzles are arrayed, which eject a coating material toward a coating portion of a vehicle, the cleaning device for a coating device comprising:
a coating material circulation passage comprising a supply passage that supplies the coating material toward the coating head;
a return flow passage that is connected to a coating material evacuation side of the coating head and recovers the coating material that was not ejected from the nozzles; and
the coating head;
a head switching valve installed in the coating material circulation passage connecting a head section including the coating head and a non-head section adjacent to the head section;
a first cleaning liquid supply part for supplying a first cleaning liquid to the head section;
a second cleaning liquid supply part for supplying a second cleaning liquid, which is different from the first cleaning liquid, to the non-head section;
a cleaning control part for controlling a switching state of said head switching valve, and a supply state of said first cleaning liquid and the second cleaning liquid;
wherein the cleaning control part, during cleaning of the coating material circulation passage, shuts off the connection between the head section and the non-head section by switching the head switching valve and supplies the first cleaning liquid to clean the head section, and/or supplies the second cleaning liquid to clean the non-head section.

2. The cleaning device for a coating device according to claim 1, further comprising:
one or more partition switching valves that are installed in the coating material circulation passage in the non-head section and partition the coating material circulation passage into a plurality of predetermined areas; and
a partition cleaning liquid supply part that supplies a different partition cleaning liquid for each predetermined area as the second cleaning liquid to the plurality of predetermined areas;
wherein the cleaning control part, during cleaning of the coating material circulation passage, partitions a portion of the coating material circulation passage into the predetermined areas by switching the partition switching valves and supplies the partition cleaning liquid by means of the partition cleaning liquid supply part to the predetermined areas to perform cleaning.

3. The cleaning device for a coating device according to claim 1, further comprising:
a pressurization part that pressurizes the cleaning liquid supplied to the coating material circulation passage; and
a suction part that sucks from the coating material circulation passage and discharges the cleaning liquid supplied by the pressurization part.

4. The cleaning device for a coating device according to claim 1, wherein the coating device is configured for:
forward direction cleaning, in which at least one of the first cleaning liquid and the second cleaning liquid in the coating material circulation passage flow from the supply passage to the return flow passage; and
reverse direction cleaning, in which at least one of the first cleaning liquid and the second cleaning liquid in the coating material circulation passage flow from the return flow passage to the supply passage, are alternately performed.
